(19) United States
(12) Patent Application Publication
(10) Pub. No.: US 2006/0169193 A1
(43) Pub. Date: Aug. 3, 2006

(54) Ornament for a vehicle antenna

(75) Inventors: John M. Mack, Goodyear, AZ (US); Paul A. Gruber, Chandler, AZ (US)

Correspondence Address: Jordan M. Meschkow;Meschkow & Gresham, P.L.C., Suite 409, 5727 North Seventh Street, Phoenix, AZ, 85014, US

(73) Assignee: Korupt Kitens, L.L.C.

(21) Appl. No.: 11/046,105

(22) Filed: Jan. 28, 2005

(51) Int. Cl. G09F 21/04

(52) U.S. Cl. 116/28 R

(57) ABSTRACT

An ornament (20) for a vehicle antenna (22) includes a rigid, non-planar body (24) arranged substantially vertical relative to the antenna (22). The body (24) has discrete first and second apertures (28, 30). The first aperture (28) is located at a lower extremity (32) of the body (24) and the second aperture (30) is located at an upper extremity (34) of the body. The ornament (20) fits loosely on the antenna (22) so that the ornament (20) can swing around the antenna (22) in response to wind currents.

### TECHNICAL FIELD OF THE INVENTION

The present invention relates to the field of antenna ornaments. More specifically, the present invention relates to ornaments for use with vehicle antennas reflective of individual interests and for vehicle-identification marking.

### BACKGROUND OF THE INVENTION

Numerous vehicle antenna ornaments have been utilized to indicate personal interests and hobbies, to show support for sporting teams, school, country, to personalize a vehicle, and for purposes of entertainment and advertising. More practically, antenna ornaments are utilized when a group of vehicles travel as a convoy or so that motorists can more readily spot their vehicles in a crowded parking lot. This is especially useful when the motorist has borrowed or leased the vehicle which he or she is driving, and is consequently less familiar with its appearance.

A large number of these antenna ornaments are antenna toppers. An antenna topper is generally mounted to and resides at the up most tip, i.e., the terminal end, of the vehicle antenna. Antenna toppers come in a variety of balls, sporting helmets, heads, animals, symbols, and the like. Unfortunately, these antenna toppers can present a large cross section area to the wind, thus tending to cause excessive bowing of the antenna as the vehicle moves about. Additionally, while an antenna topper is visible from a distance due to its height, it can be readily blown off of the antenna when the vehicle moves along a street or highway. Consequently, some prior art antenna toppers have specialized clips, friction fit central bores, locking mechanisms, and the like that drive up the complexity of design, hence the final cost of the antenna topper to the consumer.

Attempts have been made to create lightweight antenna ornaments so as to mitigate the problems associated with excessive weight and antenna bowing. One prior art antenna ornament, in the form of a human figure, is manufactured from soft polyurethane foam. The figure is arranged vertical relative to the antenna, and a central bore is directed from the base of the figure's torso through the top of the figure's head. The soft polyurethane foam is an inexpensive material. Therefore, this polyurethane foam figure can be inexpensively manufactured and sold.

Unfortunately, however, the soft polyurethane foam is not very durable. Polyurethane tends to deteriorate when exposed to weather, and it is not suitable for applications where there is friction or abrasion. In this antenna mounted application, the antenna ornament is continuously exposed to the degrading effects of heat, both ambient and reflected from the vehicle and the roadway. The antenna ornament is also continuously exposed to the degrading effects of ultraviolet radiation, rain, snow, freezing weather, and the like. In addition, the ornament is exposed to continuous friction and abrasion along the central bore. Movement of the vehicle effectively increases the adverse effects of this friction and abrasion due to the wind resistance against the antenna ornament, leading to tearing of the ornament from the antenna.

Flags and banner type ornaments also suffer damage due to wind currents. For example, flag and banner type ornaments can shred due to the severe flapping that they undergo when the vehicle travels at high speeds. In addition, in order for flags and banners to be decipherable, they require wind to animate them. Accordingly, flag and banner type ornaments are typically collapsed and illegible when the vehicle is parked or otherwise not moving.

In addition to the aforementioned problems, individuals are continuously seeking unique ways to express their individual interests, to convey humor, or simply to stand out in a crowded environment. Many of the prior art antenna ornaments are based on the conventional themes of balls, sporting helmets, heads, animals, flags, banners, and the like.

Thus, what is needed is an antenna ornament that places little or no strain on the up most portion of an antenna. What is further needed is an antenna ornament that is resistant to degradation, durable, economical to manufacture, and provides improved visibility, a unique appearance, and eye-catching movement.

### SUMMARY OF THE INVENTION

Accordingly, it is an advantage of the present invention that an antenna ornament is provided.

It is another advantage of the present invention that an antenna ornament is provided that resides significantly below the tip of an antenna.

It is another advantage of the present invention that an antenna ornament is provided that is durable and resistant to deterioration when exposed to weather.

Another advantage of the present invention is that an antenna ornament is provided that is unique in appearance.

Yet another advantage of the present invention is that an antenna ornament is provided that is economical to manufacture.

The above and other advantages of the present invention are carried out in one form by an ornament for an antenna comprising a rigid, non-planar body having discrete first and second apertures dimensioned to enable passage of the antenna.

The above and other advantages of the present invention are carried out in another form by an ornament for an antenna comprising a rigid, non-planar body configured for arrangement substantially vertical relative to the antenna. The non-planar body includes discrete first and second apertures dimensioned to enable passage of the antenna. The first aperture is located at a lower extremity of the non-planar body, and the second aperture is located at an upper extremity of the non-planar body.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a front view of an antenna ornament in accordance with a preferred embodiment of the present invention;

FIG. 2 shows a side view of the antenna ornament of FIG. 2;

FIG. 3 shows a top perspective view of the antenna ornament of FIG. 1 residing on a vehicle antenna;

FIG. 4 shows a side view of an antenna ornament in accordance with an alternative embodiment of the present invention; and

FIG. 5 shows a side view of an antenna ornament in accordance with another alternative embodiment of the present invention.

### DETAILED DESCRIPTION OF THE PREFERRED EMBODIMENTS

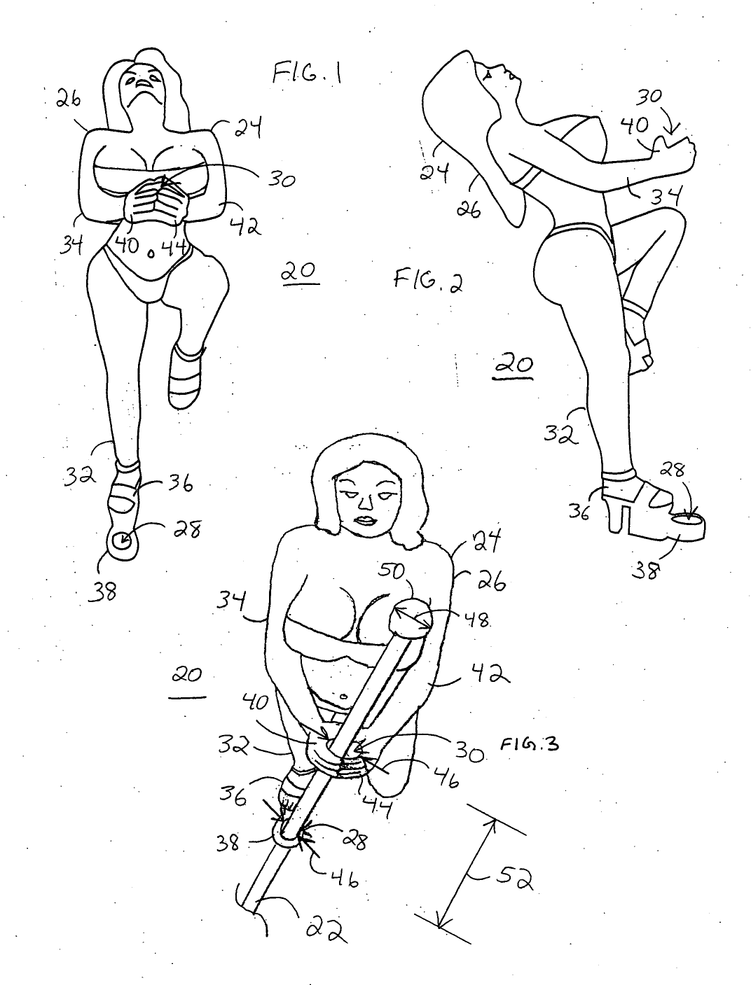

Referring now to the embodiment as illustrated in FIGS. 1-3, FIG. 1 shows a front view of an antenna ornament 20 in accordance with a preferred embodiment of the present invention. FIG. 2 shows a side view of antenna ornament 20, and FIG. 3 shows a top perspective view of antenna ornament 20 residing on a vehicle antenna 22. Although antenna ornament 20 is described in terms of is coupling to vehicle antenna 22, it should be understood that the present invention can be adapted for coupling to a number of antennas and other devices having an elongate, slender shape.

Antenna ornament 20 comprises a rigid, non-planar body 24. In a preferred embodiment, body 24 is a figure in the form of a woman 26 that is configured to be arranged substantially vertical, i.e., standing upright, relative to antenna 22.

Non-planar body 24 is constructed of a rigid plastic, such as polyvinyl chloride (PVC). PVC is preferred because it is strong, lightweight, durable, and resistant to weather related deterioration. In addition, PVC can be painted and/or dyed, is readily available, inexpensive, and is a versatile manufacturing material. Although PVC is preferred, those skilled in the art will recognize that other materials may be utilized with suitable properties such as rigidity, weather resistance, durability, easy workability, and the like. Such suitable materials may include high density polyethylene, polypropylene, polystyrene, olefins, and the like.

Non-planar body 24 includes a first aperture 28 and a second aperture 30 that is discrete, or separate, from first aperture 28. In a preferred embodiment, first aperture 28 is located at a lower extremity 32 of body 24, and second aperture 30 is located at an upper extremity 34 of body 24. As shown, lower extremity 32 includes a foot 36 to which an extension member 38 is attached. First aperture 28 is formed in extension member 38. Upper extremity 34 includes a first hand 40, and body 24 includes a second upper extremity 42 having a second hand 44. As shown, second aperture 30 is formed between clasped first and second hands 40 and 44, respectively. First and second apertures 28 and 30 are located relatively far apart to yield stable mounting of body 24 onto antenna 22.

Each of first and second apertures 28 and 30, respectively, exhibits a diameter 46 that is greater than an antenna diameter, and more specifically a diameter 48 of a terminal end 50 of antenna 22. Consequently, terminal end 50 of antenna 22 can pass completely through first and second apertures 28 and 30 so that non-planar body 24 is able to reside on antenna 22 significantly below terminal end 50 of antenna 22. Alternatively, diameter 46 may be smaller than diameter 48 of terminal end 50, yet larger than the diameter of antenna 22. In such a situation, installation of antenna ornament 20 would entail removal of antenna 22 from its mount on the vehicle, typically by unscrewing a threaded portion. Ornament 20 could then be slid onto antenna 22 from its base, and antenna 22 could subsequently be reattached to the vehicle. The smaller diameter 46 of first and second apertures 28 and 30, respectively, would largely prevent ready removal of ornament 20 from antenna 22 by theft or by wind currents.

Since antennas are typically of a uniform diameter, antenna ornament 20 is likely to reside near a base (not shown) of antenna 22. In this lower location, as opposed to positioning proximate terminal end 50, antenna ornament 20 will not cause excessive bowing of antenna 22 as the vehicle moves. In addition, this lower location makes it significantly more difficult for antenna ornament 20 to be blown off of the vehicle when the vehicle moves along a street or highway.

In terms of aesthetics, this lower location allows antenna ornament 20 to be easily visible to the occupants inside the vehicle. Moreover, the sizing of first and second apertures 28 and 30, respectively, enables loose fit of non-planar body 24 on a length 52 of antenna 22 so that antenna ornament 20 is free to swing around antenna 22 subject to wind currents. This further adds to the aesthetic appeal and entertainment value of antenna ornament 20. However, since body 24 is constructed of a rigid plastic, such as PVC, this wind induced movement about antenna 22 will cause insignificant abrasion of antenna ornament 20 at first and second apertures 28 and 30, respectively.

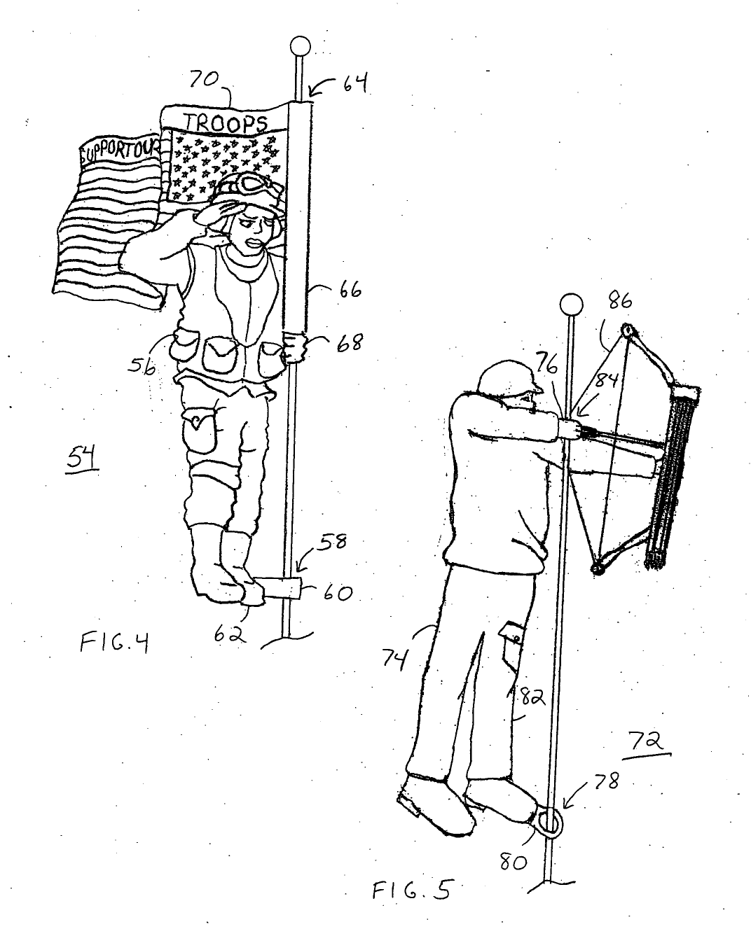

FIG. 4 shows a side view of an antenna ornament 54 in accordance with an alternative embodiment of the present invention. Antenna ornament 54 includes a rigid, non-planar body 56 in the form of a soldier. Antenna ornament 54 includes many of the features described in connection with antenna ornament 20 (FIG. 1). For example, antenna ornament 54 is configured to be arranged substantially vertical relative to antenna 22, is constructed of rigid plastic, and includes discrete first and second apertures.

Antenna ornament 54 further represents a configuration in which extension members may extend from either or both of an upper extremity and a lower extremity. As shown, body 56 includes a first aperture 58 passing through a first extension member 60 that extends from a lower extremity 62 of body 56. In addition, a second aperture 64 passes through a second extension member 66, in the form of a flagpole, extending from an upper extremity 68 of body 56.

Antenna ornament 54 includes a rigid banner 70 in the form of a flag held by the soldier of ornament 54. In this instance, antenna ornament 54 may include markings in support of an organization, such as the military. Since the banner is rigid, it can be readily visualized without animation of the banner by the wind. In addition, the banner cannot shred or rip in the wind due to its rigidity. Those skilled in the art will recognize that body 56 and banner 70 can take on a number of forms, and banner 70 can include a variety of indicia in support of or representing any of a number of organizations.

FIG. 5 shows a side view of an antenna ornament 72 in accordance with another alternative embodiment of the present invention. Antenna ornament 72 includes a rigid, non-planar body 74 in the form of a sportsman, and in this case, an archer. Although the sportsman is depicted as an archer, it should be readily apparent that the sportsman may represent any of a variety of sports, such as a ball player, golfer, a dancer, and the like. Antenna ornament 72 also includes many of the aforementioned features of antenna ornaments 20 (FIG. 1) and 54 (FIG. 4).

Antenna ornament 72 represents a configuration in which an aperture is formed utilizing only one extremity, namely a hand 76. As shown, body 74 includes a first aperture 78 passing through a first extension member 80 that extends from a lower extremity 82 of body 74. In addition, a second aperture 84 is formed as hand 76 clasps and draws back on a bowstring 86.

In yet another configuration (not shown), one of the apertures may pass through an extremity. For example, an aperture may extend completely through the foot. By utilizing the extremities, the two apertures can be located relatively far apart to yield stable mounting of the body of the antenna ornament onto vehicle antenna 22.

In summary, the present invention teaches an antenna ornament that includes two discrete apertures through which a vehicle antenna may be directed. The two discrete apertures yield stable mounting of the antenna ornament onto a vehicle antenna, and enables the ornament to be slid down and reside significantly below the tip of an antenna. In addition, the antenna ornament is constructed of a rigid plastic that is durable, resistant to deterioration when exposed to the outside elements, and economical to manufacture. The antenna ornament is unique in appearance and can swing around the antenna adding to its aesthetic appeal and entertainment value, and visibility in a crowded parking lot. Despite its ability to move about the antenna, the rigid plastic construction results in a device that is resistant to abrasive wear.

Although the preferred embodiments of the invention have been illustrated and described in detail, it will be readily apparent to those skilled in the art that various modifications may be made therein without departing from the spirit of the invention or from the scope of the appended claims.

What is claimed is:

1. An ornament for an antenna comprising a rigid, non-planar body having discrete first and second apertures dimensioned to enable passage of said antenna.

2. An ornament as claimed in claim 1 wherein said non-planar body is configured to be arranged substantially vertical relative to said antenna.

3. An ornament as claimed in claim 1 wherein:
said first aperture is located at a lower extremity of said non-planar body; and
said second aperture is located at an upper extremity of said non-planar body.

4. An ornament as claimed in claim 3 wherein said non-planar body comprises a figure, said lower extremity includes a foot, and said upper extremity includes a hand.

5. An ornament as claimed in claim 4 wherein said hand is a first hand, and said figure includes a second hand, said second aperture being formed between clasped first and second hands of said figure.

6. An ornament as claimed in claim 3 further comprising an extension member coupled to one of said lower and said upper extremities, and a corresponding one of said first and second apertures extends through said extension member.

7. An ornament as claimed in claim 1 wherein each of said first and second apertures exhibits a diameter that is greater than an antenna diameter of said antenna to enable loose fit of said non-planar body on a length of said antenna.

8. An ornament as claimed in claim 1 wherein said non-planar body is constructed of a rigid plastic.

9. An ornament as claimed in claim 8 wherein said rigid plastic is polyvinyl chloride.

10. An ornament as claimed in claim 1 wherein said rigid, non-planar body is in the form of a woman.

11. An ornament as claimed in claim 1 wherein said rigid, non-planar body is in the form of a soldier.

12. An ornament as claimed in claim 1 wherein said rigid, non-planar body is in the form of a sportsman.

13. An ornament for an antenna comprising a rigid, non-planar body configured for arrangement substantially vertical relative to said antenna, said non-planar body including discrete first and second apertures dimensioned to enable passage of said antenna, said first aperture being located at a lower extremity of said non-planar body, and said second aperture being located at an upper extremity of said non-planar body.

14. An ornament as claimed in claim 13 wherein said non-planar body comprises a figure, said lower extremity includes a foot, and said upper extremity includes a hand.

15. An ornament as claimed in claim 14 wherein said hand is a first hand, and said figure includes a second hand, said second aperture being formed between clasped first and second hands of said figure.

16. An ornament as claimed in claim 13 further comprising an extension member coupled to one of said lower and said upper extremities, and a corresponding one of said first and second apertures extends through said extension member.

17. An ornament as claimed in claim 13 wherein said rigid, non-planar body is in the form of a woman.

18. An ornament for an antenna comprising a rigid, non-planar body having discrete first and second apertures dimensioned to enable passage of said antenna, said first and second apertures exhibiting a diameter that is greater than an antenna diameter of said antenna to enable loose fit of said non-planar body on a length of said antenna, said first aperture being located at a lower extremity of said non-planar body, and said second aperture being located at an upper extremity of said non-planar body.

19. An ornament as claimed in claim 18 wherein said non-planar body is constructed of a rigid plastic.

20. An ornament as claimed in claim 18 wherein said non-planar body is constructed of polyvinyl chloride.
